(19) United States
(12) Patent Application Publication
(10) Pub. No.: US 2008/0194237 A1
(43) Pub. Date: Aug. 14, 2008

(54) DISTRIBUTED ELECTRONIC PHONEBOOK

(76) Inventors: ANDREY V. MATYUSHEV, West Des Moines, IA (US); ALEKSEY MATYUSHEV, Daytona Beach, FL (US)

Correspondence Address: MCKEE, VOORHEES & SEASE, P.L.C., 801 GRAND AVENUE, SUITE 3200, DES MOINES, IA, 50309-2721, US

(21) Appl. No.: 11/853,141

(22) Filed: Sep. 11, 2007

Related U.S. Application Data
(60) Provisional application No. 60/900,530, filed on Feb. 12, 2007.

(51) Int. Cl. H04M 3/42; H04M 3/00

(52) U.S. Cl. 455/414.1; 455/419

(57) ABSTRACT

A method for providing an electronic phonebook to a phone includes providing a software application to the phone for accessing the electronic phonebook, providing an electronic phonebook database accessible using the software application, wherein the software application provides for displaying phonebook information from the phonebook database to a user of the phone in a hierarchical format organized by business segment and business sub-segment. The software application also provides for making calls from electronic phonebook, updating phonebook database and tracking use of the phone for calling listings identified through use of the electronic phonebook database.

### CROSS-REFERENCE TO RELATED APPLICATIONS

This application claims priority under 35 U.S.C. § 119 to provisional application Ser. No. 60/900,530 filed Feb. 12, 2007, herein incorporated by reference in its entirety.

### BACKGROUND OF THE INVENTION

The present invention relates to phone listings, more particularly, but not exclusively the present invention relates to phone listings and related services for use with various communication devices, such as, without limitation, mobile phones or communication devices, wireless phones or communication devices, conventional landline phones, voice over Internet Protocol (VoIP) phone or communication devices, or other types of communication devices.

Paper-based phone books are well known for providing listings for persons and businesses. Paper-based phone books may also include advertising in addition to business listing, such as in the form of yellow page advertising. Yet paper-based phone books do not provide an adequate solution to mobile phone users, who do not generally have the paper-based phone book available when needed. Paper-based phone book tend to be out of date. The phone number search in the paper-based phone book is time consuming. Also, conventional phonebook includes phone listings only from one area code. Thus, using conventional phone books is inconvenient for phone users, especially for the mobile phone users.

Another approach that may be used to find listings for persons and businesses is to attempt to search for such information on the Internet through a search engine or other web site. However, one problem with such an approach is that it is again inconvenient for phone users to do so. Even for the mobile phones that provide web-enabled functionality, sometimes such functionality is slow or data connections can not be made. In addition, using a web browser to attempt to access such information can be inconvenient and time-consuming to use.

It is also observed that phones typically allow users to store phone numbers for frequently called people or businesses. Sometimes this information may be considered a phonebook and may be stored internal to the phone or on a SIMM card. However, this is very limited information and requires efforts by users to store the phone numbers.

Another problem associated with conventional phone books is the ability of advertisers to track how well advertising in phonebooks is working for them, and their return on their investment. This is particularly true where advertisers may advertise in a variety of different phone books.

Another problem associated with advertising in phone books is that decisions to advertise and the advertisement to use, are often done on an annual basis as the phone book is typically printed only once a year.

Another seemingly unrelated problem is associated with short message services (SMS) messages. It is observed that currently advertisers are using SMS messages to deliver advertisements and promotions to devices such as mobile phones. The SMS messages usually appear to be sent and received at the wrong time, with the wrong advertisement or promotion, and thus the use of SMS messages is inefficient, and potentially bothersome to users.

Thus, problems remain with the use of paper phone books for all phone users, particularly for mobile phone users.

### BRIEF SUMMARY OF THE INVENTION

Therefore, it is a primary object, feature, or advantage of the present invention to improve over the state of the art.

It is another object, feature, or advantage of the present invention to provide a directory for use by phones that is directly accessible by the phone.

One or more of these and/or other objects, features, or advantages of the present invention will become apparent from the specification and claims that follow.

According to one aspect of the present invention, a method for providing an electronic phonebook on a phone is provided. The method includes providing a software application to the phone for accessing the electronic phonebook and providing an electronic phonebook database accessible using the software application. The software application provides for displaying phonebook information from the phonebook database to a user of the phone in a hierarchical format organized by business segment and business sub-segment.

According to another aspect of the present invention, a method for providing an electronic phonebook on a phone includes providing a software application to the phone for accessing the electronic phonebook, and providing an electronic phonebook database accessible using the software application. The software application provides for tracking use of the phone for calling listings identified through use of the electronic phonebook database. The software application may also provide for presenting an advertising message to the user of the phone while the phone performing functions indicative of the user making a call decision.

### BRIEF DESCRIPTION OF THE DRAWINGS

FIG. 1 is a block diagram illustrating a mobile phone having access to a phonebook database through the software application.

FIG. 2 is a diagram of a hierarchy associated with one embodiment of an electronic phonebook.

FIG. 3 is a flow diagram illustrating selections made by a user using the electronic phonebook.

FIG. 4A illustrates representative screen displays of a mobile phone using the electronic phonebook.

FIG. 4B illustrates additional representative screen displays of a mobile phone using the electronic phonebook.

FIG. 5 is a block diagram illustrating interactions or information flow between advertisers and a phonebook service provider.

FIG. 6 is a block diagram illustrating interactions or information flow between a user and a phonebook service provider.

### DETAILED DESCRIPTION OF THE PREFERRED EMBODIMENT

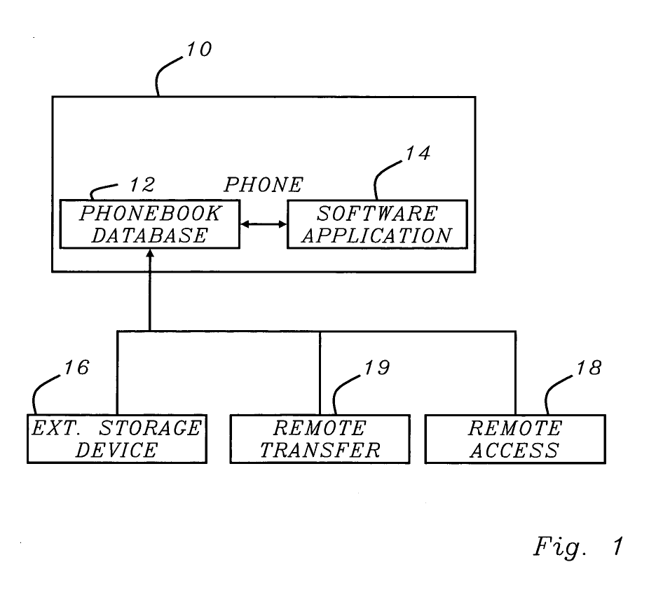

According to a first aspect of the present invention, an electronic phonebook is provided to the phone. FIG. 1 is a block diagram representing a phone 10 which may, but need not be a mobile phone. The phone 10 has executing on it a software application 14 which access a phonebook database 12. The phonebook database includes business listings, advertisements, ratings, and other types of information as described later herein. The phonebook database 12 may be stored within the external storage device 16, such as, but not limited to a SD card, micro-SD card, or other type of removable storage device. The present invention contemplates that where a removable storage device is used, the removable storage device may be sold, leased, rented, given to, or otherwise provided to a user. Instead of being stored on an external storage device 16, the phonebook database may be distributed through a remote transfer operation 19, where the phonebook database 12 is downloaded to the phone 10.

The software application 14, executing on the phone provides for access to the phonebook database, whether the phonebook database is stored internally in the phone, stored within an external device or removable device operatively connected to the phone. The software application 14 may be distributed to the phone through the same means as the phonebook database, through an external storage device or through a remote transfer operation or installed any other way. The software application may be integrated with phonebook database in one distributable package or provided as a separate module. The software application 14 may be implemented in any number of ways. One preferred implementation is to use Java. More and more mobile phones are now Java-enabled. One of the benefits of using Java is that the same software can be used on phones from different manufacturers, using different processors. Of course, the software may be otherwise implemented. It is preferred that the mobile phone supports Java MIDP 2.0 or higher. However, the software may be developed for any number of operating systems, including, but not limited to Blackberry, Symbian, and Windows Mobile OS, iPhone OS X, or other operating systems.

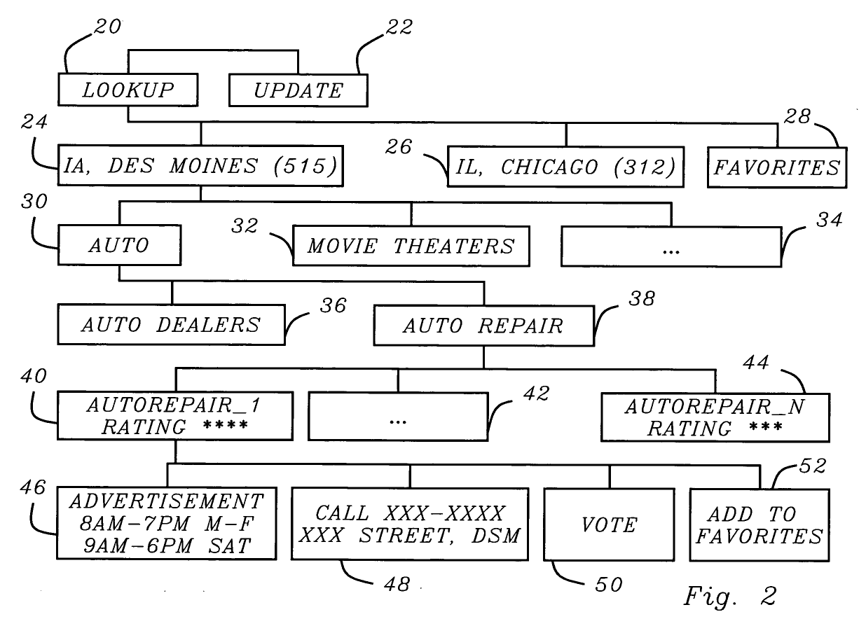

FIG. 2 is a diagram of a hierarchy associated with one embodiment of an electronic phonebook. As shown in FIG. 2, the software application allows a user to select whether they wish to “LOOKUP” 20 a business or to “UPDATE” 22 their phonebook database 12. The update action provided through remote access 18. The software application periodically generates an automatic reminder message that phonebook database is outdated and needed update. The software application asks for phonebook database update and provides automatic update every time when remote access is available. This update action would be available to convey information to or from the mobile phone and the provider of the electronic phonebook. Thus, for example, where a copy of the phonebook database exists on the phone, updating may compare the local copy of the phonebook database with the most current phonebook database available and then update the local copy of the phonebook database accordingly. Such a feature, is advantageous in that current information is available to a user of the phone. A phone user relying on a conventional paper phonebook would not have updated information more recently than the last printing of the phonebook, and thus may benefit from this advantage. In addition to this information, other types of information may also be updated. This may include the rating associated with each listing or the enhanced advertising associated with listings. In addition, the “UPDATE” 22 also contemplates transferring information from the phone of a user to the provider of the electronic phonebook. This may include the ratings give to various businesses by the user of the phone, favorite listings of the user of the phone, demographic information about the user, calls made to various businesses listed within the electronic phonebook, or other information.

The software application allows a user to select “LOOKUP” 20 for an area code or favorites. The present invention contemplates that there may be practical limitations to the size of the electronic phonebook that a user may place on their phone as well as to the area in which the user will usually use the electronic phonebook. One convenient way to provide the user with a manageable set of information is by area code. Thus, or example, a user may have an area code such as 515 associated with Des Moines, Iowa 24 on their phone and an area code such as 312, associated with Chicago, Ill. 26 on their phone. In addition to organizing the electronic phonebook by area codes for presentation to the user, listings may also be designated as “FAVORITES” 28. The present invention contemplates that the favorites list 28 may be constructed in various ways, such as by a user's specific addition of an entry to the “FAVORITES” 28 category. Alternatively, each time a user ranks a business, it may be added to “FAVORITES” 28 category, or each time a user calls a business, it may be added to the “FAVORITES” 28 category. In these, or other ways, those listings of most interest or potential interest to a user may be maintained.

For each area code, or other grouping, a user is allowed to select a business segment, such as “AUTO” 30 or “MOVIE THEATERS” 32, or other type of business segment 34. Once this selection has been made, a sub-segment may be selected. For example, where “AUTO” 30 is selected, a user may then select “AUTO DEALERS” 36 or “AUTO REPAIR” 38 or other sub-segment or category. The present invention contemplates that there may be various numbers of levels of categories or sub-segments present. As shown in FIG. 2, various business are listed under “AUTO REPAIR” 38, including a first auto repair business (“AUTOREPAIR1”) 40, a last auto repair business (“AUTOREPAIR_N”) 44, and any number of intermediary auto repair businesses 42. Note that for each auto repair business, there may be a rating present. The rating may be a user rating, a compilation of user ratings, or other type of rating. After a business such as the first auto repair business 40 is selected, information about the business is displayed. This may include an advertisement 46 which may provide hours of operation, promotions, or other information. It includes contact information 48 which includes a phone number and may include a street address. In addition, the user of the phone is presented with the opportunity to “VOTE” 50 or rate the business. In addition, the user of the phone may select to “ADD TO FAVORITES” 52 in order to add the business to their “FAVORITES” 28.

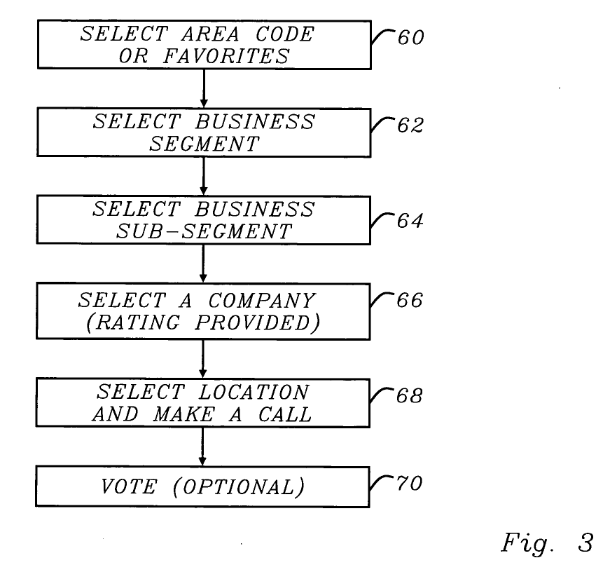

FIG. 3 further illustrates the methodology which may be use. In step 60, the user selects to access either particular area code or else their favorites. Next, in step 62, the user selects a business segment of interest. In step 64, the user selects a business sub-segment of interest. In step 66, the user selects a business. Ratings for the business may be provided. Then in step 68, where there are multiple locations for the business, the user selects the location of interest and the phone connects to the corresponding phone number. The user also has the opportunity to vote or rate the business 70 according to their personal experience with the business.

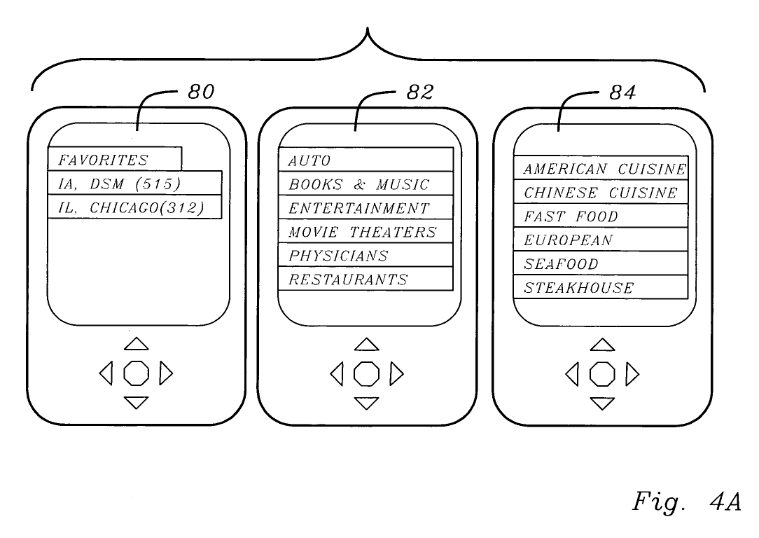

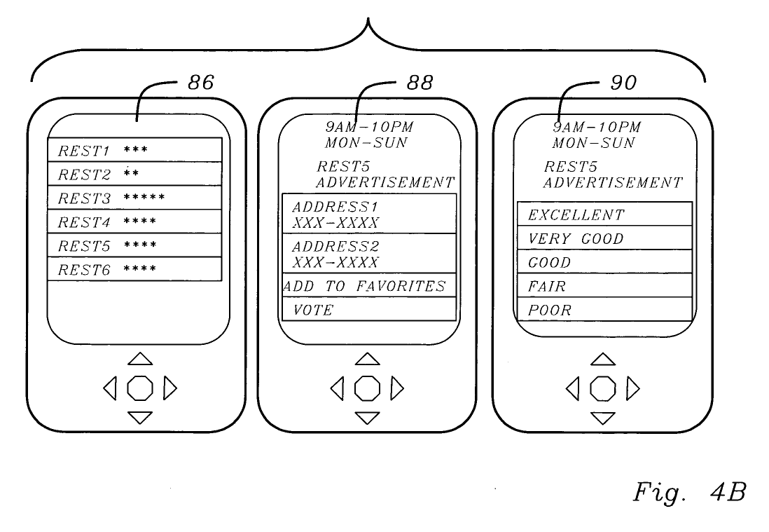

FIG. 4A and FIG. 4B illustrate representative screen displays of a mobile phone using the electronic phonebook. In FIG. 4A, screen display 80 illustrates how a user can select an area code or their favorites. Screen display 82 illustrates how a user can select a business segment. Screen display 84 illustrates how a user can select a sub-segment. In FIG. 4B, screen display 86 illustrates a number of businesses listed, one of which can be selected by a user. Ratings are shown for each of the businesses listed in screen display 86. In screen display 88, information about a selected business, in this case restaurant “REST5” are shown. An advertisement is also displayed for the business. In this case the restaurant “REST5” has multiple locations. Thus, a user has access to information about all locations. The user may select the location in order to connect with the restaurant using the phone.

Once a phone number to call has been selected or otherwise identified by the user, the phone number may be automatically dialed. Thus, information about the user's selection of a particular business or phone number may be stored. This information may later be collected during the phonebook update and potentially shared with advertisers so that they can track their return on investment for advertising dollars spent. In addition, more complex analyses may provide additional information, such as by correlating selections made by users to particular characteristics of the user, or determining the demographics for users who call a particular business.

Because the phone may automatically dial the phone number, the present invention contemplates that after connecting, the phone may play a prerecorded voice message to alert the recipient of the phone call that the user found the phone number though advertising on the particular service. The prerecorded voice message or greeting message is preferably short and concise, so as to be minimally obtrusive to the user or the person answering the phone. In this way, the advertisers will also be provided with direct feedback regarding the use of the service. The prerecorded voice message may identify the electronic phonebook by name, indicate that the caller should be given preferential service because they used the electronic phonebook, or otherwise provides a message that can be identified by the advertiser as being associated with the electronic phonebook, while being minimally obtrusive to the user of the mobile phone.

The user also has the option to add the business to their favorites or to vote or provide a rating or evaluation of the business. Screen display 90 shows one methodology for allowing a user to rate the business as either “EXCELLENT”, “VERY GOOD”, “GOOD”, “FAIR” or “POOR.” This rating system may correspond to a number of stars, such as five stars, “*****” for excellent, four stars, “****” for very good, “three stars, “**”, for good, two star, “**”, for fair, and one star, “*” for poor. Of course, other types of rating systems may be used.

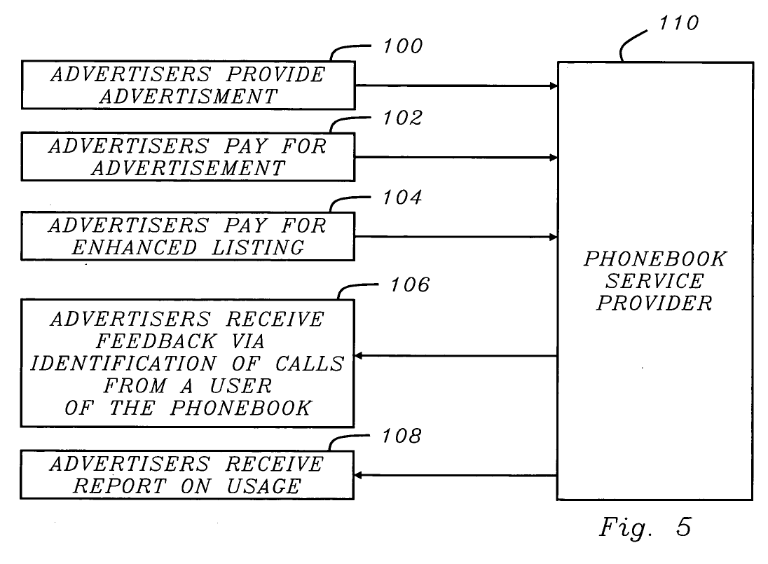

FIG. 5 is a block diagram illustrating interactions or information flow between advertisers and a phonebook service provider. In FIG. 5, advertisers may provide an advertisement 100 to the phonebook service provider 110. In addition, the advertisers may pay for the advertisement 102. Alternatively, the advertisers may pay for an enhanced listing 104. The service provider, then makes the advertisement or other type of enhanced listing available as a part of the electronic phonebook. According to one embodiment of the present invention, advertisers pay a fee for enhanced listings. The enhanced listings can take a number of forms. For example, the enhanced listings may include advertisements similar to those associated with paper phone books where the listing is emphasized through being in bold, all uppercase characters, or in a larger font than other listings. The advertisements may also be similar to those in yellow page listings where an advertisement of the business's choice is provided. The enhanced listings may take on other forms, such as the position of the business within listings for a category associated with the business. The present invention contemplates that different service fees may be associated with different positions of the business within a particular listing. Thus, for example, a business which wishes to be first in a particular list, such as a listing of business for a particular business sub-segment, may ensure that they are listed first through paying a higher service fee than a business content to be second in the listing. Note that this advantageous over a traditional phonebook where businesses are arranged alphabetically.

In addition, the service provider may provide additional value-added services. For example, advertisers may receive feedback from a user of the phonebook.

In addition the advertisers may receive reports on usage of the electronic phone book, including their business listings. The present invention contemplates that these reports may include various types of information of interest to the advertisers, such as but not limited to:
Number of times the advertisement or enhanced listing has been viewed.
Number of times the advertiser's business has been called by users of the electronic phonebook.
Ratings for the business provided by users, including averages, and statistical reports.
Comparative analysis and statistical reporting for different locations of a business, time of day that calls were made, time of day that advertisements or enhanced listing were viewed.
Comparative analysis and statistical reporting for other businesses in the same business sub-segment, including ratings, number of times, called, and other competitive intelligence.

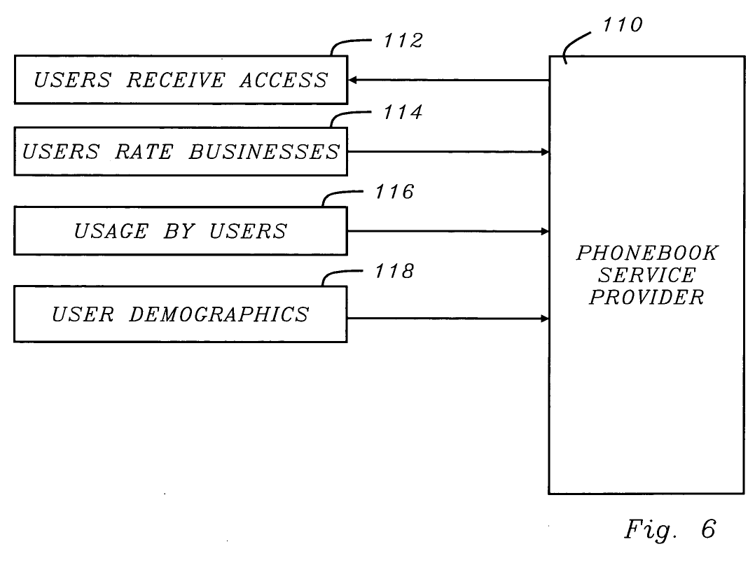

FIG. 6 is a block diagram illustrating interactions or information flow between a user and a phonebook service provider 110. The interactions and information flow include the user receive access 112 to the electronic phonebook. In addition, information from the user to the phonebook service provider 110 may include users rate businesses 114 to provide user ratings or other types of user feedback. A rating system is one convenient manner for providing user feedback. Any rating system used should be easy to use and understand. Examples of such rating systems include a one-to-five star rating system, a one-to-ten rating system, or other type of rating system. Other information provided by users of the electronic phonebook to the electronic phonebook service provider 110 includes information regarding usage of the electronic phonebook by users 116. This information may include advertisements or enhanced listings viewed, calls to businesses, time of calls, location of the mobile phone at the time of viewing or time of call, businesses identified as favorites, user preferences, area codes associated with the user, and other information.

Other information provides by users of the electronic phonebook to the electronic phonebook service provider includes user demographics 118. The present invention contemplates that information collected from a user may be collected in a manner that preserves the privacy of the individual, but still provides valuable information to the phonebook service provider who can in turn provide this to advertisers or others. Demographic information, may include for example, user gender, age, user's cell phone carrier, user's type of phone, and area codes associated with a use. This information can provide advertisers and other businesses with meaningful information regarding their customers and potential customers as well as the effectiveness of the electronic phonebook as an advertising tool.

The present invention contemplates that additional features may also be used with the electronic phonebook. For example, address information may also be included within the listing to assist users in finding the business. The present invention contemplates that the user's current location may be mapped along with the location of the business to assist the user in finding the business. Directions may also be generated to assist the user in finding the business from their current location.

The present invention contemplates that instead of using the hierarchical tree of segments of businesses, that a keyword search may be performed on the content of the electronic phonebook database. The present invention contemplates that where a keyword search is performed, this feature provides additional opportunities for enhanced listings through the ordering of the results, or otherwise.

The present invention contemplates that the present invention provides value in a number of ways. A user is provided significant convenience in locating business listings when using the electronic phonebook of the present invention. Thus, the present invention further contemplates that the users may pay a fee. The fee may be structured in various ways. For example, where an external storage device is used, a fee may be charged for the external storage device and for the licensing of the database stored on the external storage device. In addition, fees may be charged for periodic updating of this information. The present invention contemplates, that information needed for charging a small service per use may be tracked. The present invention further contemplates that the small service fee may be adjusted by user activities. For example, if a user rates a business which they called, they may be credited at least a portion of what is charged. The present invention also contemplates, that no fee is required by users.

The present invention contemplates that value is created for advertisers who advertise on the service. Advertisers may be charged set fees for their advertisements. Alternatively, they may be charged for the reports provided to them regarding their customers and potential customers or for the number of times users use the electronic phonebook to find the advertisers.

Another aspect of the present invention relates to the presentation of advertising messages to users at appropriate times. The software application associated with the electronic phonebook may provide for presenting an advertising message to the user of the phone while the phone is performing functions indicative of the user making a call decision. For example, the advertising message may be presented while the user is examining different business listing within a business sub-segment. This is advantageous over using SMS to advertise as the advertising message is provided to the user may be targeted to what is of interest to the user given their expression of interest in a particular business sub-segment. In addition, this is advantageous over using SMS to advertise as the phonebook advertising message is provided to the user at the exact time of the user's interest, and when they are making a decision as to whether to call or who to call. The advertising message also does not impede on the user's readability of the information as a “pop-up” ad would.

It is to be understood that although mobile phones or other types of mobile communication devices are described in some of the preferred embodiments, the phone or other communications device need not be a mobile phone, as a conventional phone having a landline may also be used. The phone being used may also use VOIP technology, or other type of communications technology.

Although various embodiments of the present invention have been described herein, the present invention is not to be limited to the specific disclosure provided, as the present invention contemplates that numerous variations, options, and alternatives may fall within the broad spirit and scope of the invention.

What is claimed is:

1. A method for providing an electronic phonebook on a phone, comprising:
providing a software application to the phone for accessing the electronic phonebook;
providing an electronic phonebook database accessible using the software application;
wherein the software application provides for displaying phonebook information from the phonebook database to a user of the phone in a hierarchical format organized by business segment and business sub-segment.

2. The method of claim 1 wherein the software application provides for updating the electronic phonebook database.

3. The method of claim 1 wherein the software application is implemented using Java.

4. The method of claim 1 further comprising receiving from a user of the phone a selection of a phone number from the electronic phonebook database to connect with.

5. The method of claim 4 further comprising establishing a connection with the selection of the phone number.

6. The method of claim 5 further comprising playing a voice message after the step of establishing the connection.

7. The method of claim 6 wherein the voice message includes information indicative of use of the electronic phonebook database.

8. The method of claim 5 further comprising tracking information associated with use of the electronic phonebook database.

9. The method of claim 8 wherein the tracking information includes number of times that a listing within the electronic phonebook database is dialed by the phone.

10. The method of claim 8 wherein the tracking information includes number of times that a listing associated with the selection is viewed on the phone.

11. The method of claim 1 wherein the step of providing the electronic database comprises providing the electronic database on a digital storage medium accessible by the phone.

12. The method of claim 1 wherein the step of providing the electronic database comprises transferring the electronic database or accessing the electronic database using a wireless communication link.

13. The method of claim 12 wherein the wireless communication link is a cellular communication link.

14. The method of claim 12 wherein the wireless communication link is a wireless ethernet link.

15. The method of claim 1 wherein the step of providing the electronic database comprises downloading at least a portion of the electronic database.

16. The method of claim 1 wherein the software application provides for receiving a user rating for a business listed in the electronic database.

17. The method of claim 1 wherein the software application provides for displaying user ratings for businesses listed in the electronic database.

18. The method of claim 1 wherein the software application provides for presenting an advertising message to the user of the phone while the phone is performing functions indicative of the user making a call decision.

19. The method of claim 1 wherein each of the business sub-segments comprises a plurality of business listings.

20. The method of claim 19 wherein a position of each of the plurality business listings within the business sub-segment being determined at least partially based on size of a fee associated with the position.

21. The method of claim 1 wherein the phone is a mobile phone.

22. The method of claim 2 wherein the software application further provides for periodically providing a reminder that the phonebook database is outdated.

23. The method of claim 2 wherein the software application further provides for automatically updating the phonebook database through remote access.

24. The method of claim 1 wherein the phonebook information comprises phone listings from multiple area codes.

25. A method for providing an electronic phonebook on a phone, comprising:
providing a software application to the phone for accessing the electronic phonebook;
providing an electronic phonebook database accessible using the software application;
wherein the software application provides for displaying phonebook information from the phonebook database to a user of the phone in a hierarchical format organized by business segment and business sub-segment;
wherein the software application further provides for presenting an advertising message to the user of the phone while the phone is performing functions indicative of the user making a call decision;
wherein the software application provides for tracking use of the phone for calling listings identified through use of the electronic phonebook database.
